(19) United States
(12) Patent Application Publication
(10) Pub. No.: US 2015/0151497 A1
(43) Pub. Date: Jun. 4, 2015

(54) COMPOSITE ASSEMBLY AND MANUFACTURING METHOD THEREOF

(71) Applicant: B & S OHG, Paderborn (DE)

(72) Inventor: Sven Schulz, Bonn (DE)

(21) Appl. No.: 14/552,980

(22) Filed: Nov. 25, 2014

(30) Foreign Application Priority Data
Dec. 2, 2013 (DE) 10 2013 020 368.6

(51) Int. Cl. B29C 70/68; B29C 67/00

(52) U.S. Cl. CPC B29C 70/68; B29C 67/0066; B33Y 80/00

(57) ABSTRACT

A composite assembly with a base body formed without tools by means of rapid prototyping as a form-giving component of the composite assembly having at least one longitudinal void, which has at least two and preferably three or more access ports, with a plurality of elongated stabilization fibers provided in the longitudinal void of the base body and have a higher tensile strength than the plastic material of the base body, and with a filler material, which, like the stabilization fibers, is provided in the longitudinal void of the form-giving body and, for the permanent fixing of the stabilizing fibers in the longitudinal void, is connected on the one hand to the base body and on the other hand is connected to the stabilization fibers.

The invention relates to a composite assembly with a shape-giving base body, which is reinforced and optimized with respect to its durability by stabilization fibers. The invention further relates to a method of manufacturing the composite assembly.

A composite assembly of this type is today conventionally produced by producing the body in a molding method, for example by plastic injection molding. Typically in this case, the stabilization fibers are already embedded during the manufacture of the base body. Thus the composite assembly is produced in a single manufacturing process. Here, foams or tools are required for the production. Due to the tooling costs, is not cost justified to manufacture the same composite assembly as a one-off or in small production series. In addition, the negative master severely restricts the shape of the composite assembly since the tool must be separated from the composite assembly after the curing. In addition, the manufacture of composite assemblies with a complex geometry, for example, through-holes, threaded inserts, etc., is costly and thus economically disadvantageous.

It is the object of the present invention to provide a composite assembly, which can be produced economically in small quantities or as individual parts and offers great freedom in terms of the geometry and shape. It is another object of the invention to provide a method of manufacturing the composite assembly.

To achieve the object, a composite assembly according to the invention comprises a base body made of a plastic material without a mold in the manner of rapid prototyping as a shape-giving component of the composite assembly having at least one longitudinal void, which has at least two and preferably three or more access openings, and a plurality of elongated shaped stabilizing fibers, which are provided in the longitudinal void of the base body and exhibits a greater rigidity than the plastic material of the base body, and a filler material, which, like the stabilization fibers, is provided in the longitudinal void of the shaping body, and for the permanent bonding of the stabilizing fiber in the longitudinal void, is bonded to the base body on the one hand and to the stabilization fibers on the other hand.

The particular advantage of the invention is that the body is made as a shape-giving component of the composite assembly without tools in the manner of rapid prototyping and thus may have almost any geometry. In particular complex geometric structures, threaded sections, undercuts, and cavities may be provided which can not be manufactured with conventional molding methods of forming a body. Since the plastic material of the base body generally has a low strength, a longitudinal void or opening or recess will be provided in the base body. The longitudinal void receives stabilizing fibers, which have a higher rigidity than the plastic material of the base body. The stabilizing fibers assume a supportive or stabilizing function, which the sometimes brittle plastic material of the body cannot provide. For the permanent connection of the stabilizing fibers to the base body for the production of the composite, the parts of the longitudinal void which are not filled with the stabilizing fibers are filled with the filler material. The filler material has the task of connecting the fibers and stabilizing the body to form a functional unit.

The filler material used is, for example, a thermoplastic or a thermosetting plastic. Preferably, the filler material in a cured state is stable, rugged and tough.

In a further development of the invention a plurality of access openings are provided in the longitudinal void. For example, access openings for the introduction of the fibers, more access openings for the introduction of the filler material and other access openings are provided for creating a vacuum or an overpressure in the longitudinal void. A plurality of access openings can be provided at the end sections of the longitudinal void or distributed along the longitudinal direction of the longitudinal void.

According to another embodiment, the base is designed for accommodating loads. For this purpose, the longitudinal void is provided with the stabilizing fibers and the filler material in a region of a maximum shear, tensile or bending stress. The load-oriented design of the body serves, firstly, to protect the composite assembly from damage, particularly in the areas of maximum stress. On the other hand, as a result of the load-oriented design, the volume and the weight of the body and the stabilizing fibers can be minimized. It thereby decreases the manufacturing complexity and cost of the composite assembly.

According to the invention, the composite assembly is provided by a manufacturing method comprising the steps of:
producing the shaping-giving base body by an additive process with the at least one longitudinal void provided therein and the plurality of access openings in a layer building-up process for a fluid and/or granular and/or plasticized basic material, wherein localized energy is supplied and/or the fluid and/or granular and/or plasticized base material is solidified;
removing non-solidified base material out of the longitudinal void of the base body, wherein the unsolidified base material is removed via at least one access opening;
introducing the stabilizing fibers into the longitudinal void, wherein the stabilizing fibers are inserted through the access opening;
positioning the stabilizing fibers in the longitudinal void;
establishing a pressure difference between the pressure in the longitudinal void and ambient pressure;
at least partially filling the remaining volume of the longitudinal void with the filler material;
solidifying the filler material.

The particular advantage of the method is that with the layer build-up method, the geometry of the forming body can be created sequentially and chosen almost arbitrarily and that in particular internal longitudinal voids are produced, which can be formed curved or bent or angled. The longitudinal voids provided for receiving stabilizing fibers can therefore be made individualized in the areas of maximum stress. With classical primary shaping manufacturing processes, which make use of a tool or a mold, this is not possible or only to a very limited extent. For example, the base body is manufactured directly from a computer model and a data set derived therefrom, without requiring manufacture of geometric prototypes or volume models. A topology optimization—for example in the form of a load-oriented design of the body or of the composite assembly—can be achieved in cost-effective and time-saving manner on a 3D CAD model.

In order to introduce a sufficient amount of filler material into the longitudinal void of the base body after the introduction of the stabilizing fibers, according to the invention a pressure difference is provided between the ambient pressure (atmospheric pressure) and the pressure in the longitudinal void. For example, a negative pressure or a positive pressure is produced in the longitudinal void. Due to the pressure difference the filling material comes largely automatically into the longitudinal cavity and fills the remaining volume at least in part. Through the process parameters, the choice of the filler material itself and its flow characteristics in particular the degree of filling can be varied and in particular the density of the composite can be specifically adjusted. It can therewith be ensured that the functionally required bonding of the stabilizing fibers with the base body is achieved and the composite assembly has the required strength and stability. The establishment of the pressure difference reduces the process time. In addition, by providing the pressure difference in the longitudinal void during production of the composite, the residual volume which is not filled by the stabilizing fibers or by the filling material can be very small. The pressure differential also ensures that the filling material in any case reaches locally between the stabilizing fibers. The result is a very good bonding of the stabilizing fibers themselves. The filler material, which is in particular introduced in liquid form, can for example be self-hardening at room temperature.

Optionally according to the invention it may be provided that an inner surface of the longitudinal void is in any case sealed in sections after the production of the base body. For example, the sealing is done by surface coating the longitudinal void. For example, a material for producing the seal can be introduced into the longitudinal void and soak through the inner lateral surface of the base body or in any case locally diffuse to produce the seal. The seal is used in particular to establish or improve the air tightness of the longitudinal void. Further, the seal serves as a primer for better adhesion between the base material and the filler material.

According to another embodiment, the filler material is introduced in the heated state in the longitudinal void. Depending on the properties of the filler material, this results in, for example, a better fluidity, so that the filling process is accelerated and the filling can be optimized. Similar materials can be used for example for the filling material and the main body. Materials from the same material group—for example, an SLS part made of PA and a filler material made of PA—can be used.

According to another embodiment, the filler material and the stabilizing fibers can be introduced simultaneously in the longitudinal void. This can be done for example via separate access openings. For example, the stabilizing fibers and the filler material may be mixed prior to introduction into the longitudinal groove and then introduced together through the same access opening in the longitudinal void. There can be injected for example a thermoplastic matrix with short fibers in the longitudinal void.

According to another embodiment, the filler material can harden upon application of heat or UV irradiation. Advantageously, by the application of accelerating power, the process of curing is initiated in controlled manner and can be time controlled. The procedure can be used to influence the nature and form of the composite.

Parts produced by the process can be used for example when complex geometries are required, which can not be satisfied with conventional composite assemblies, and when the required degree of customization is very high. Possible applications are found, among others, in the aerospace, medical, automotive, equipment and special machinery fields as well as in sports. The composite assembly is in this case characterized by an excellent ratio of strength to weight. It can be very specifically adapted in terms of its structure, the strength and geometry to a specific application, in that in particular by the type, number and orientation of the fibers chosen individually locally different strengths or mechanical properties are achieved. With the method according to the invention, it becomes possible, for example, with selection of appropriate materials and the choice of a suitable layered construction method, to produce pure-material partially fiber reinforced monocoque components, in that for example by a stereolithography part is combined with a fiber composite material based on epoxy resin or a thermoplastic laser sintered part is combined with a matrix of the same material introduced in a heated state.

From the dependent claims and the following description the other advantages, features and details of the invention can be seen. The there mentioned features can individually or in any combination be essential for the invention. Features and details of the invention described with reference to the composite assembly are applicable also in the context of the process of the invention, and vice versa. So the disclosure of individual aspects of the invention always applies both ways. The drawings are merely illustrative for clarification of the invention and are not restrictive.

Embodiments of the invention are explained in detail with reference to drawings. In the drawings:

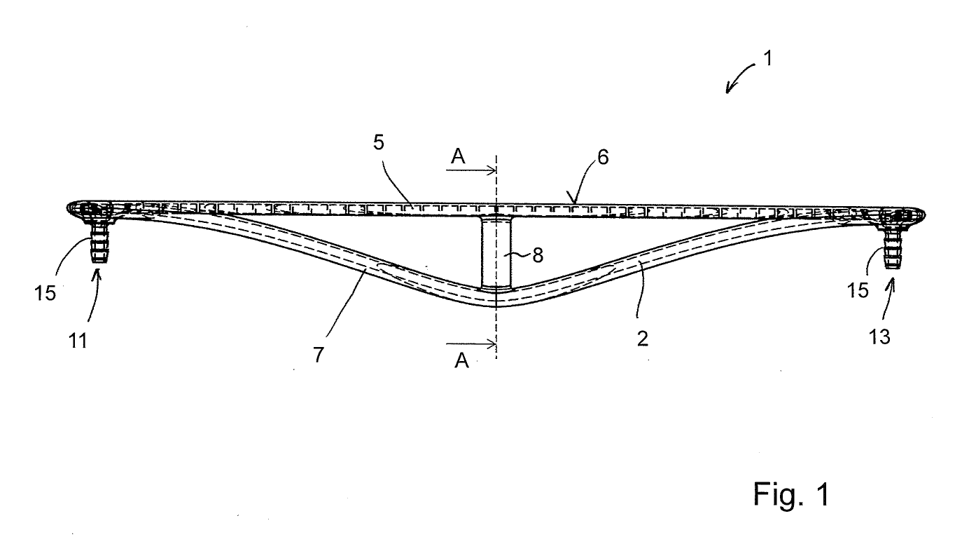

FIG. 1 is a composite assembly according to the invention in a side view,

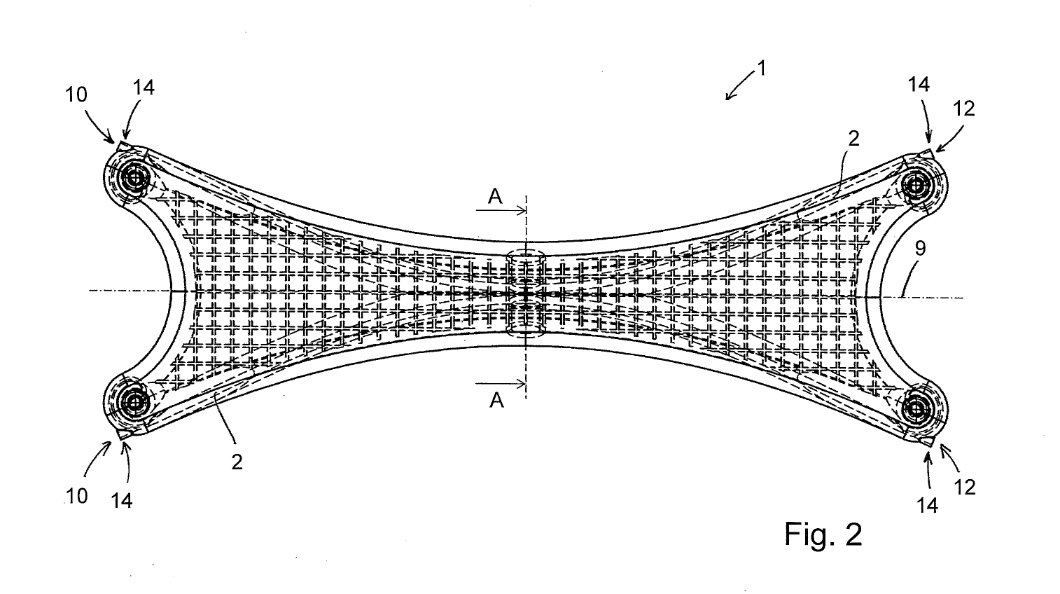

FIG. 2 is a plan view of the composite assembly of the invention shown in FIG. 1,

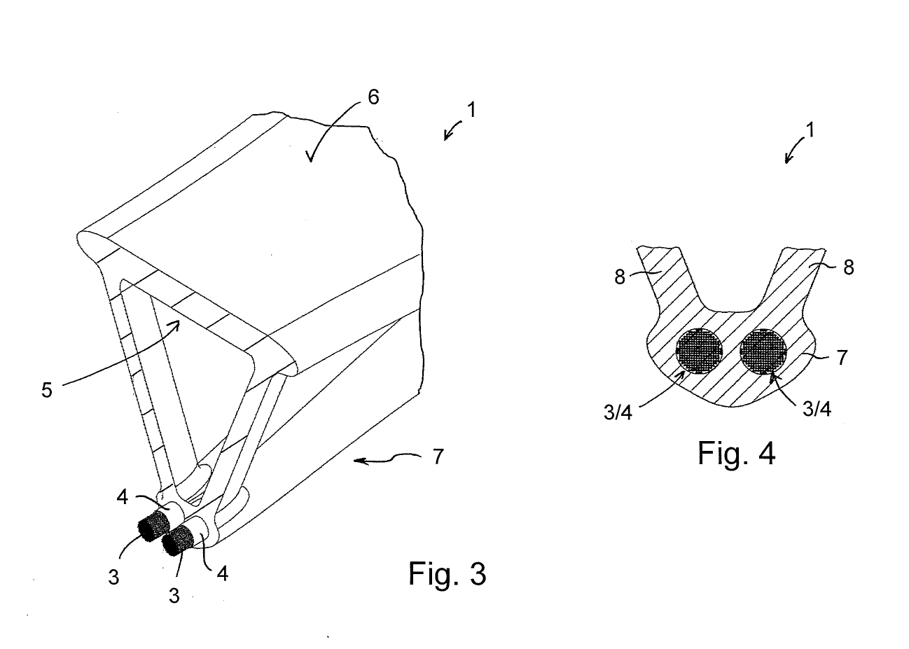

FIG. 3 is a perspective sectional view of the composite assembly of the invention of FIG. 1 according to the section A-A,

FIG. 4 is a detail view of a sectional area of FIG. 3 and

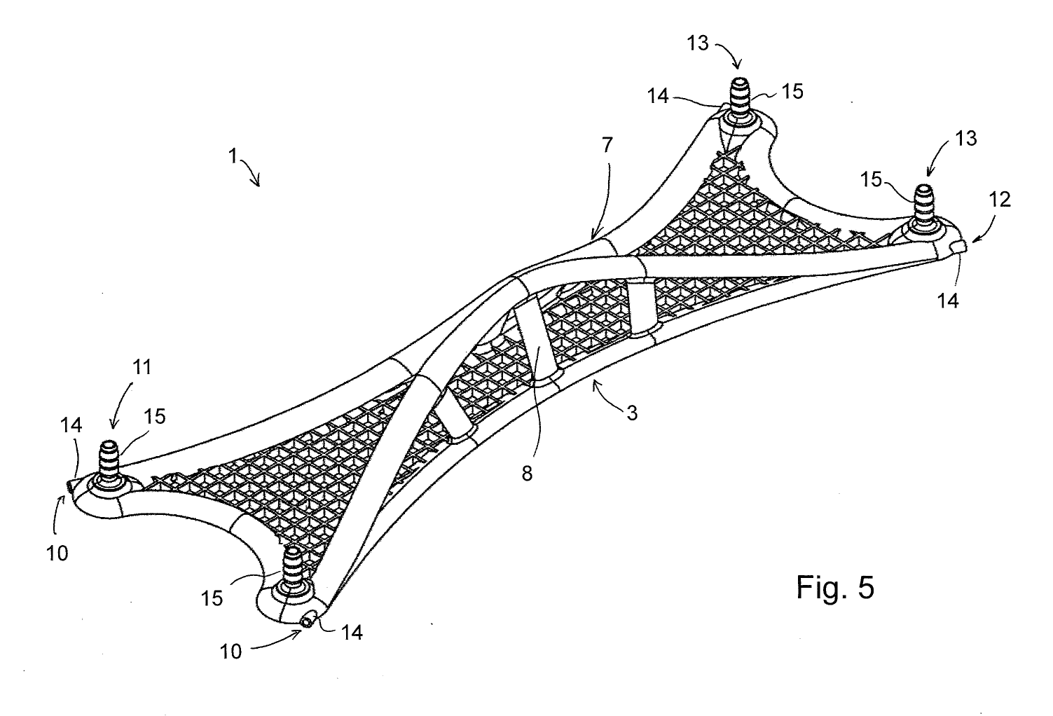

FIG. 5 is a bottom perspective view of the composite device of FIG. 1 according to the invention.

A composite assembly according to the invention comprises, as essential components, a bridge shaped form-giving base body 1 with two longitudinal voids 2 extending between two opposing narrow ends of the base body 1, and, provided in the longitudinal void 2, stabilizing fibers 3 and a filler material 4. The filler material 4 is used to join the stabilizing fibers 3 to the base body 1 and is also provided in the longitudinal void 2. The main body 1 has a functional section 5 having a substantially planar functional surface 6 as well as a load path oriented support section 7, which is provided on the function section 5 on the side facing away from the functional surface 6. The longitudinal void 2 is provided in the support section 7. Struts 8 are provided between the functional section 5 and the support section 7 for connecting the sections 5, 7.

The composite assembly is symmetrical in relation to a longitudinal central axis 9, with one longitudinal void 2 provided on each of the sides of the longitudinal central axis 9. Each longitudinal void 2 has four access ports 10, 11, 12, 13, which are respectively pairwise assigned to two oppositely lying end sections of the longitudinal voids 2. In a first end segment of the longitudinal void 2 a first access opening 10 is provided extending in the direction of the longitudinal void 2. The first access opening 10 is realized as a part of a tubular connection piece 14 provided on the main body 1, wherein the connection piece 14 extends in the direction of the longitudinal void 2. A second access opening 11, which is also associated with the first end section of the longitudinal void 2, extends perpendicular to the functional surface 6 of the base body 1 in the direction of the bottom of the main body 1. The second access opening 11 is part of a further connecting piece 15, which in the region of an outer surface is in profiled formed as a segment of a circle. A third access opening 12 in the area of an opposing second end region of the longitudinal void 2 is realized analogous to the first access opening 10 as a part of a further connecting piece 14, and a fourth access opening 13 as a part of a connection piece 15.

For producing the composite assembly, in a first manufacturing step the base body 1 is made using a layer forming method with a fluid or granular base material, wherein localized energy is supplied, and the fluid, plasticized or granular base material is locally solidified. During the manufacture of the base body 1, the longitudinal void 2 is formed integrally in the process, in that solidification of the base material locally in the region of the longitudinal void 2 is avoided. Following the production of the base body 1 unconsolidated working material situated in the longitudinal void 2 is removed via the access openings 10, 11, 12, 13 provided in the longitudinal void 2. Then the stabilization fibers 3 are introduced through the access openings 10, 11, 12, 13 into the longitudinal void 2. Further, any remaining volume of the longitudinal void 2, which is not filled with the stabilizing fibers 3, is at least partially filled with a filler material 4. In order to introduce the filler material 4 reliably into the longitudinal void and to promote the distribution of the filler material 4 in the longitudinal void 2, a negative pressure is produced in the longitudinal void 2. For this purpose, in the present embodiment of the invention the first and third access openings 10, 12 are hermetically sealed with a plug (not shown). A vacuum or pressure reducing pump is connected to the second access opening 11. The filling material 4 is then introduced into the longitudinal void 2 through the remaining fourth access opening 13. Once a sufficient quantity of the filler material 4 is provided in the longitudinal void 2, the filling material 4 can be solidified. For example, the solidification can be effected by UV irradiation or the addition of heat.

Since the filler material 4 produces the permanent connection of the stabilizing fibers 3 to the base body 1, it is advantageous to have the highest possible degree of filling of the remaining volume of the longitudinal void 2 with the filler material 4. For example, after the hardening of the filler material 4, a residual volume of less than 85%, preferably a residual volume of less than 70%, and most preferably a residual volume of less than 50% of the longitudinal void 2 remains, which is not filled either with the stabilization fibers 3 nor with the filler material 4. Disregarded in this case is a remaining functional shadow volume, which is constituted of the access openings 10, 11, 12, 13 and the connecting pieces 14, 15.

The same components and component functions are designated with the same reference numerals.

1. A composite assembly comprising
a base body (1) produced without tools in the manner of rapid prototyping as a form-giving component of the composite assembly having at least one longitudinal void (2), which has at least two and preferably three or more access openings (10, 11, 12, 13),
a plurality of elongate formed stabilizing fibers (3), which are provided in the longitudinal void (2) of the base body (1) and have a higher tensile strength than the plastic material of the base body (1), and
a filler material (4), which like the stabilizing fibers (3) is provided in the longitudinal void (2) of the shaping body (1) and, for the permanent fixing of the stabilizing fibers (3) in the longitudinal void (2) is connected on the one hand with the base body (1), and on the other hand is connected with the stabilizing fibers (3).

2. The composite assembly according to claim 1, wherein in a first end region of the longitudinal void (2) at least a first access opening (10) and adjacent thereto a second access opening (11) are provided and that at least a third access port (12) is provided in an oppositely lying second end region of the longitudinal void (2).

3. The composite assembly according to claim 1, wherein the filler material (4) is thermoplastic or duroplastic type and/or that the filling material (4) is shape-stable in a solidified state.

4. The composite assembly according to claim 1, wherein the base body (1) is designed to be stressable such that the stabilizing fibers (3) and the filling material (4) filled longitudinal void (2) in provided in the region of a maximum shear and/or tensile and/or bending stress.

5. The composite assembly according to claim 1, wherein, as part of the base body (1), at least one connecting piece (14, 15) is provided with at any rate partially tubular geometry, and that the connecting piece (14, 15) provides an access opening (10, 11, 12, 13) for the longitudinal void (2).

6. The composite assembly according to claim 1, wherein a closing plug is provided for at least one access opening (10, 11, 12, 13), wherein a geometry of the closing plug is adapted to the geometry of the access opening (10, 11, 12, 13) and/or a material for the stopper is selected such that the access opening (10, 11, 12, 13) is hermetically sealed with the sealing plug.

7. A method for manufacture of a composite assembly according to claim 1, comprising the following method steps:
producing the shaping-giving base body (1) by an additive process with the at least one longitudinal void (2) provided therein and the plurality of access openings (10, 11, 12, 13) in a layer building-up process for a fluid and/or granular and/or plasticized basic material, wherein localized energy is supplied and/or the fluid and/or granular and/or plasticized base material is solidified;
removing non-solidified base material out of the longitudinal void (2) of the base body (1), wherein the unsolidified base material is removed via at least one access opening (10, 11, 12, 13);
introducing the stabilizing fibers (3) into the longitudinal void (2), wherein the stabilizing fibers (3) are inserted through the access opening (10, 11, 12, 13);
positioning the stabilizing fibers (3) in the longitudinal void (2);
establishing a pressure difference between the pressure in the longitudinal void (2) and ambient pressure;
at least partially filling the remaining volume of the longitudinal void (2) with the filler material (4);
solidifying the filler material (4).

8. The manufacturing method according to claim 7, wherein the filler material (4) is solidified by the application of heat, and/or that the filling material (4) is subjected to UV radiation to solidify same.

9. The manufacturing method according to claim 7, wherein immediately prior to the at least partial filling of the remaining volume in the longitudinal void (2) with a filler material (4), a negative pressure is produced in the longitudinal void (2) by suctioning out air via an access opening (10, 11, 12, 13).

10. The manufacturing method according to claim 7, wherein for at least partly filling the remaining volume of the longitudinal void (2) with the filler material (4) in any case single access openings (10, 11, 12, 13) are closed.

11. The manufacturing method according claim 7, wherein after the production of the base body (1) an inner surface of the longitudinal void (2) is sealed at least in part.

12. The manufacturing method according to claim 7, wherein the filler material (4) is introduced into the longitudinal void (2) in a heated state.

13. The manufacturing method according to claim 7, wherein the filler (4) and the base body (1) are made of a similar material.

14. The manufacturing method according to claim 7, wherein the stabilizing fibers (3) and the filler (4) are introduced simultaneously into the longitudinal void (2).

15. The manufacturing method according to claim 7, wherein the stabilizing fibers (3) and the filler (4) are mixed outside the longitudinal void (2) and then introduced into the longitudinal void (2).
